(19) United States
(12) Patent Application Publication
(10) Pub. No.: US 2014/0126185 A1
(43) Pub. Date: May 8, 2014

(54) BACKLIGHT MODULE

(71) Applicant: InnoLux Corporation, Miao-Li County (TW)

(72) Inventors: Ming-Feng HSIEH, Miao-Li County (TW); Shih-Chang HUANG, Miao-Li County (TW)

(73) Assignee: InnoLux Corporation, Miao-Li County (TW)

(21) Appl. No.: 14/065,897

(22) Filed: Oct. 29, 2013

(30) Foreign Application Priority Data
Nov. 5, 2012 (TW) 101140931

(51) Int. Cl. F21K 99/00

(52) U.S. Cl. CPC F21K 9/00
USPC 362/97.3

(57) ABSTRACT

A backlight module is provided, including a first light-emitting device and a second light-emitting device. The first light-emitting device includes a first blue light LED chip and a first phosphor layer having a first color spectrum, wherein the first color spectrum has a first color spectrum area with at least 70% thereof distributed within the range from 500 nm to 580 nm. The second light-emitting device includes a second blue light LED chip and a second phosphor layer having a second color spectrum, wherein the second color spectrum has a second color spectrum area with at least 60% thereof distributed within the range from 600 nm to 680 nm. The first color spectrum has a portion within the range from 590 nm to 780 nm, and the portion has a first area smaller than or equal to 10% of the second color spectrum area.

### CROSS REFERENCE TO RELATED APPLICATIONS

The present application claims priority of Taiwan Patent Application No. 101140931, filed on Nov. 5, 2012, the entirety of which is incorporated by reference herein.

### BACKGROUND OF THE INVENTION

1. Field of the Invention

The present application relates to a backlight module, and in particular relates to an LED backlight module.

2. Description of the Related Art

FIG. 1 shows a CIE 1931 chromaticity diagram introduced by the CIE (Commission International De'l E'clairage), wherein the region A in the diagram represents a color gamut defined by the CIE. In FIG. 1, a triangular region B+RG in the region A is defined as a color varying range (i.e. color gamut) of a specific LCD display. Note that, in the field of display, the area ratio of the triangular region B+RG with respect to another triangular region NTSC defined by NTSC (National Television System Committee) can be used as a performance index of the LCD. In general, the LCD is recognized to have a high color gamut when the triangular region B+RG exceeds 80% of the triangular region NTSC.

Recently, mixed-light (B+RG) LEDs have been applied in backlight modules for a display, which are composed of a blue light LED chip, a red phosphor layer, and a green phosphor layer. However, it is not easy for the green and red lights of the mixed-light (B+RG) LEDs to be separated from each other, thus, limiting the high color gamut of the display.

### BRIEF SUMMARY OF THE INVENTION

The invention provides a mixed-light LED backlight module of a display, wherein the color lights generated by the mixed-light LED can be easily separated for a higher color gamut of a display.

An embodiment of the invention provides a backlight module, comprising a first light-emitting device and a second light-emitting device. The first light-emitting device includes a first blue light LED chip and a first phosphor layer having a first color spectrum, wherein the first color spectrum has a first color spectrum area with at least 70% thereof distributed within the range from 500 nm to 580 nm. The second light-emitting device includes a second blue light LED chip and a second phosphor layer having a second color spectrum, wherein the second color spectrum has a second color spectrum area with at least 60% thereof distributed within the range from 600 nm to 680 nm. The first color spectrum has a portion within the range from 590 nm to 780 nm, and the portion has a first area smaller than or equal to 10% of the second color spectrum area.

Another embodiment of the invention provides a backlight module, comprising a first light-emitting device and a second light-emitting device. The first light-emitting device includes a first blue light LED chip and a first phosphor layer having a first color spectrum, wherein the first color spectrum has a first color spectrum area with at least 70% thereof distributed within the range from 500 nm to 580 nm. The second light-emitting device includes a second blue light LED chip and a second phosphor layer having a second color spectrum, wherein the second color spectrum has a second color spectrum area with at least 60% thereof distributed within the range from 600 nm to 680 nm. The second color spectrum has a portion within the range from 380 nm to 590 nm, and the portion has a second area smaller than or equal to 5% of the first color spectrum area.

### BRIEF DESCRIPTION OF THE DRAWINGS

The invention can be more fully understood by reading the subsequent detailed description and examples with references made to the accompanying drawings, wherein:

FIG. 1 shows a CIE 1931 chromaticity diagram and the color gamut of a conventional B+RG LED;

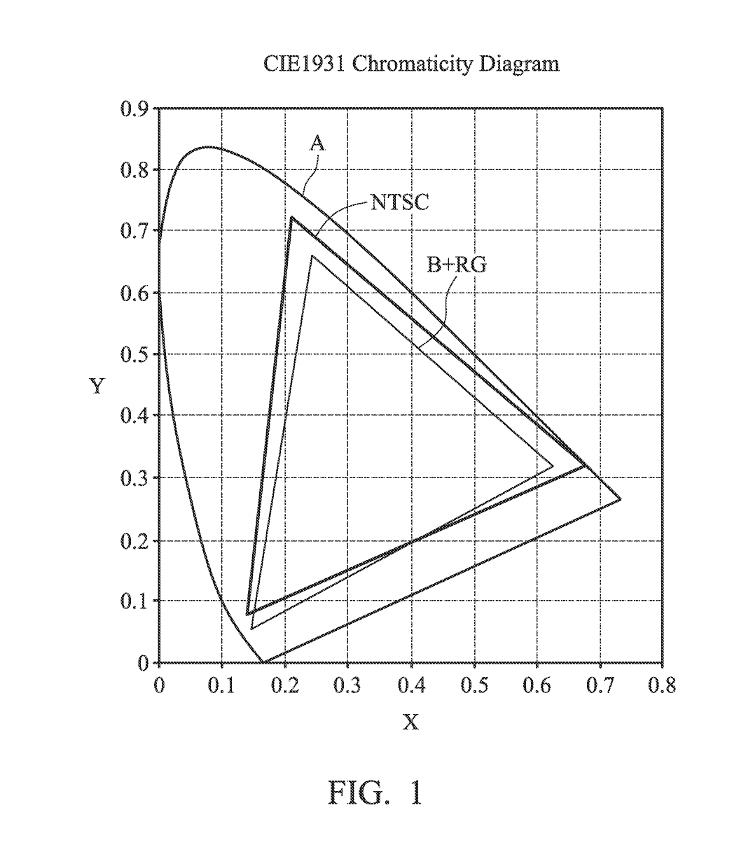

FIG. 2 is a sectional view of a backlight module according to an embodiment of the invention;

FIG. 3A is a schematic view of a light-emitting spectrum of the first light-emitting device of FIG. 2;

FIG. 3B is a schematic view of a light-emitting spectrum of the second light-emitting device of FIG. 2;

FIG. 3C is a schematic view of a light-emitting spectrum combined with the light-emitting spectrums of FIGS. 3A and 3B;

FIG. 4A schematically shows a first color spectrum moving toward a short-wavelength range;

FIG. 4B schematically shows a second color spectrum moving toward a long-wavelength range; and

FIG. 5 is a sectional view of a backlight module according to another embodiment of the invention.

### DETAILED DESCRIPTION OF THE INVENTION

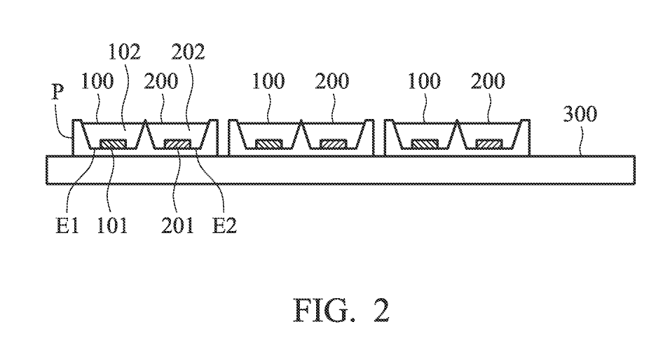

FIG. 2 is a sectional view of a backlight module according to an embodiment of the invention. As shown in FIG. 2, the backlight module comprises a plurality of first light-emitting devices 100, a plurality of second light-emitting devices 200, a plurality of package units P, and a substrate 300. The package units P are disposed on the substrate 300.

Each of the package units P includes two recesses E1 and E2 for respectively holding a first light-emitting device 100 and a second light-emitting device 200. Each of the first light-emitting devices 100 comprises a first blue light LED chip 101 and a first phosphor layer 102 covering the first blue light LED chip 101. Similarly, each of the second light-emitting devices 200 comprises a second blue light LED chip 201 and a second phosphor layer 202 covering the second blue light LED chip 201. In this embodiment, the first phosphor layer 102 includes green phosphor particles, and the second phosphor layer 202 includes red phosphor particles.

Note that the inner walls of the recesses E1 and E2 may have light reflecting layers to enhance illumination efficiency. The recesses E1 and E2 may have the same shape or different shapes, e.g. the recesses E1 are square, and the recesses E2 are circular. The sizes of the recesses E1 and E2 may be the same or different depending on the characteristics of the light sources. Additionally, the first and second blue light LED chips 101 and 201 in the recesses E1 and E2 can be controlled to emit light individually. The volumes of the first and second phosphor layer 102 and 202 in the recesses E1 and E2 may be different depending on design requirements.

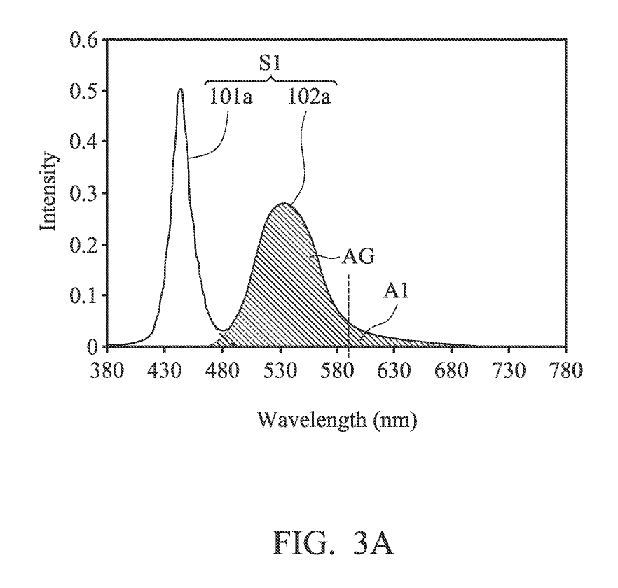

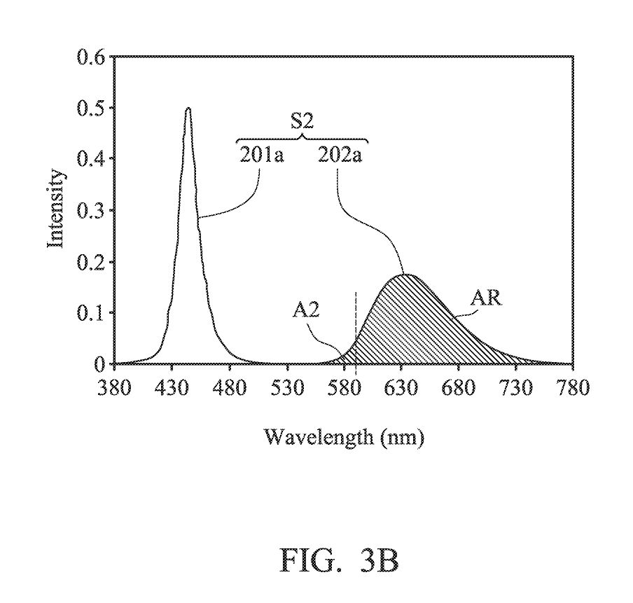

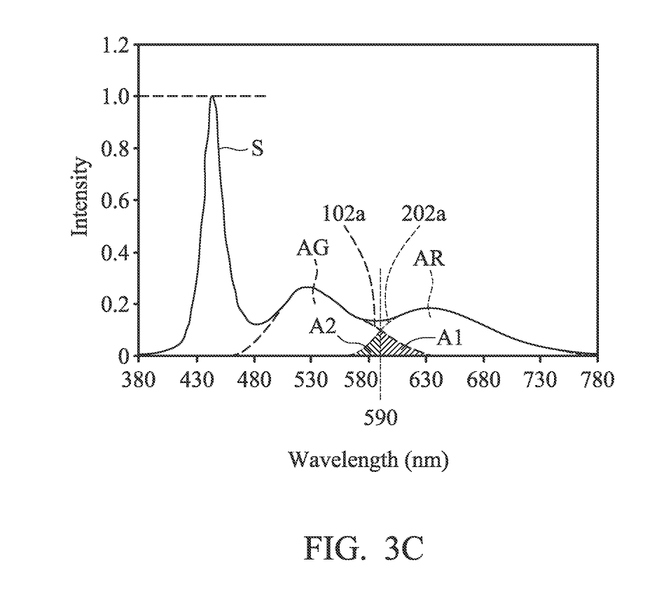

Referring to FIG. 3A, the first light-emitting device 100 has a first light-emitting spectrum S1 that is composed of a first blue light spectrum 101a and a first color spectrum 102a. The first blue light spectrum 101a is produced by the first blue light LED chip 101, and the first color spectrum 102a is produced from the first color phosphor 102 excited by blue light from the first blue light LED chip 101. The first color spectrum 102a in the visible light wavelength range (380 nm-780 nm) has a first color spectrum area AG with at least 70% thereof distributed within the range from 500 nm to 580 nm. Similarly, referring to FIG. 3B, the second light-emitting device 200 has a second light-emitting spectrum S2 that is composed of a second blue light spectrum 201a and a second color spectrum 202a. The second blue light spectrum 201a is produced by the second blue light LED chip 201, and the second color spectrum 202a is produced from the second color phosphor 202 excited by blue light from the second blue light LED chip 201. The second color spectrum 202a in the visible light wavelength range (380 nm-780 nm) has a second color spectrum area AR with at least 60% thereof distributed within the range from 600 nm to 680 nm.

Referring to the spectrum diagram of FIG. 3C, a mixed-color spectrum S is obtained by adding the first light-emitting spectrum S1 to the second light-emitting spectrum S2, wherein the wavelength 590 nm is deemed as a border between the first color spectrum 102a and the second color spectrum 202a. When the main portion of the first color spectrum area AG is distributed within a short-wavelength range below 590 nm, the rest area of the first color spectrum 102a exceeding 590 nm is small, such that the overlap area between the first and second color spectrums 102a and 202a can be small to prevent the second color spectrum 202a from being adversely influenced by the first color spectrum 102a. For the same reasons as described above, when the main portion of the second color spectrum area AR is distributed within a long-wavelength range exceeding 590 nm, the rest area of the second color spectrum 202a below 590 nm is small, such that the overlap area between the first and second color spectrums 102a and 202a can be small to prevent the first color spectrum 102a from being adversely influenced by the second color spectrum 202a. That is, when the overlap area between the first and second color spectrums 102a and 202a is smaller, the color purities thereof are higher, and the color gamut may even exceed NTSC 90% for high color gamut.

In this embodiment, the first and second light-emitting devices 100 and 200 can be respectively controlled to emit light individually or simultaneously. Referring to FIG. 3C, the wavelength of the mixed-color spectrum S produced by the backlight module distributes within the range of visible light (380 nm-780 nm). The maximal light intensity of the mixed light-emitting spectrum S is defined as 1.0. The first color spectrum 102a of the first light-emitting spectrum S1 exhibits a substantially green color, and the second color spectrum 202a of the second light-emitting spectrum S2 exhibits a substantially red color.

Referring to FIGS. 3A to 3C, the first color spectrum 102a has a portion exceeding 590 nm (590 nm-780 nm) as the first area Al shown in FIGS. 3A and 3C. For high color gamut, the overlap ratio of the first area A1 in the second color spectrum area AR should be as small as possible. A preferable condition is that the first area A1 is smaller than or equal to 10% of the second color spectrum area AR. Similarly, the second color spectrum 202a has a portion below 590 nm (380 nm-590 nm) as the second area A2 shown in FIGS. 3B and 3C. For high color gamut, the overlap ratio of the second area A2 in the first color spectrum area AG should be as small as possible. A preferable condition is that the second area A2 is smaller than or equal to 5% of the first color spectrum area AG. The aforesaid conditions may be fulfilled individually or simultaneously to make the color gamut exceed NTSC 90%.

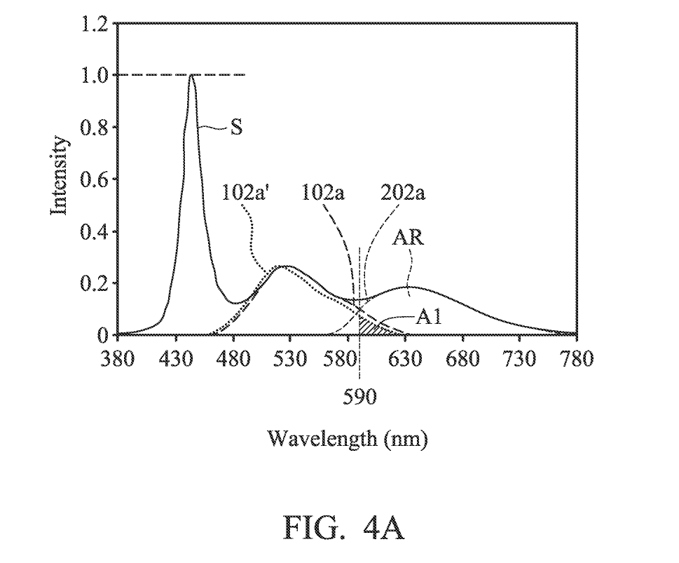

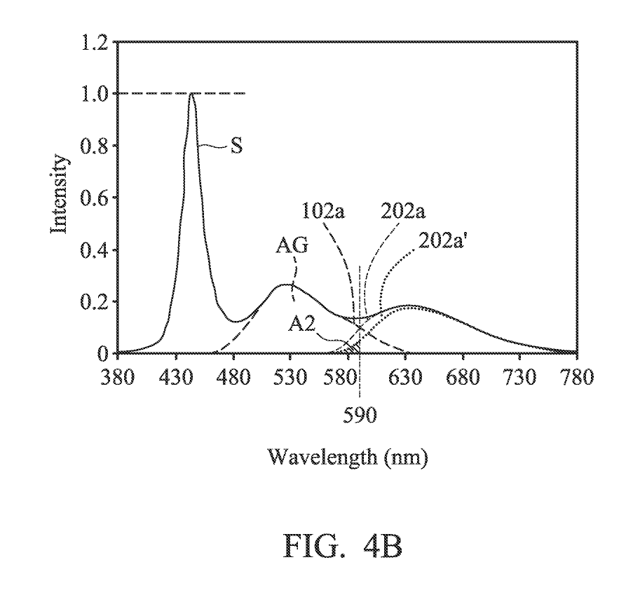

In some embodiments, the first color spectrum 102a shows a substantially green color, and the first phosphor layer 102 includes phosphor particles of nitride, silicate, or preferably sulfide. The first color spectrum 102a may shift to the left, as the waveform 102a′ shown in FIG. 4A, by adjusting the ratio of calcium, strontium, or barium ions in sulfide or silicate (e.g. increasing the ratio of barium ions, or decreasing the ratio of calcium or strontium). Thus, the first area A1 in the first color spectrum 102′ exceeding 590 nm can be reduced, and the overlap ratio of first area A1 in the second color spectrum area AR can be less than or equal to 10%.

In another embodiment, the second color spectrum 202a shows a substantially red color, and the second phosphor layer 202 includes phosphor particles of nitride or preferably sulfide. The second color spectrum 202a may shift to the right as the waveform 202a′ shown in FIG. 4B, by adjusting the ratio of nitrogen ion in nitride (e.g. increasing the ratio of nitrogen ion), or adjusting the ratio of calcium, strontium, or barium ions in sulfide (e.g. decreasing the ratio of barium ions, or increasing the ratio of calcium or strontium). Thus, the second area A2 in the second color spectrum 202′ below 590 nm can be reduced, and the overlap ratio of the second area A2 in the first color spectrum area AG can be less than or equal to 5%.

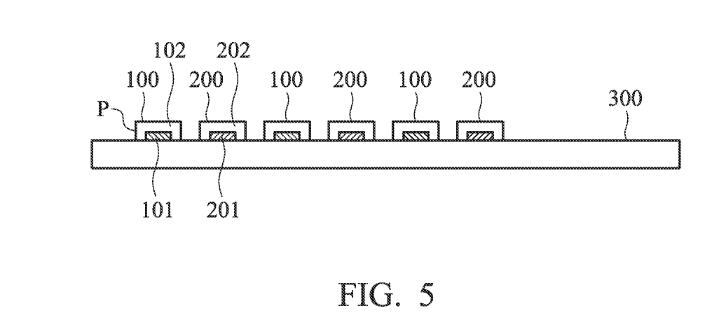

Referring to FIG. 5, another embodiment, the first and second light-emitting devices 100 and 200 may be disposed in different package units P on the substrate 300 and arranged in a staggered manner. It should be realized that the backlight module of the invention may be an edge-type or direct-type backlight module applied to an LCD.

As described above, the invention provides a backlight module including a first light-emitting device and a second light-emitting device. The first light-emitting device includes a first blue light LED chip and a first phosphor layer having a first color spectrum. The first color spectrum in the visible light wavelength range (380 nm-780 nm) has a first color spectrum area with at least 70% thereof distributed within the range from 500 nm to 580 nm. The second light-emitting device includes a second blue light LED chip and a second phosphor layer having a second color spectrum. The second color spectrum in the visible light wavelength range (380 nm-780 nm) has a second color spectrum area with at least 60% thereof distributed within the range 600 nm to 680 nm. According to an embodiment of the invention, the first color spectrum has a portion exceeding 590 nm (590nm-780 nm), and the portion has a first area smaller than or equal to 10% of the second color spectrum area. In some embodiment, the second color spectrum has a portion below 590 nm (380nm-590 nm), and the portion has a second area smaller than or equal to 5% of the first color spectrum area. Thus, the LED backlight module of the invention applied to a display can prevent spectrums mutually influence and achieve high color saturation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a first light-emitting device, including a first blue light LED chip and a first phosphor layer having a first color spectrum, wherein the first color spectrum has a first color spectrum area with at least 70% thereof distributed within the range from 500 nm to 580 nm; and
a second light-emitting device, including a second blue light LED chip and a second phosphor layer having a second color spectrum, wherein the second color spectrum has a second color spectrum area with at least 60% thereof distributed within the range from 600 nm to 680 nm, wherein the first color spectrum has a portion within the range from 590 nm to 780 nm, and the portion has a first area smaller than or equal to 10% of the second color spectrum area.

2. The backlight module as claimed in claim 1, wherein the first color spectrum exhibits a substantially green color, and the second color spectrum exhibits a substantially red color.

3. The backlight module as claimed in claim 1, wherein the backlight module further comprises a package unit with the first and second phosphor layers disposed therein.

4. The backlight module as claimed in claim 3, wherein the package unit forms two recesses with the first and second phosphor layers respectively disposed therein.

5. The backlight module as claimed in claim 1, wherein the backlight module further comprises a plurality of package units with the first and second phosphor layers respectively disposed therein.

6. A backlight module, comprising:
a first light-emitting device, including a first blue light LED chip and a first phosphor layer having a first color spectrum, wherein the first color spectrum has a first color spectrum area with at least 70% thereof distributed within the range from 500 nm to 580 nm; and
a second light-emitting device, including a second blue light LED chip and a second phosphor layer having a second color spectrum, wherein the second color spectrum has a second color spectrum area with at least 60% thereof distributed within the range from 600 nm to 680 nm, wherein the second color spectrum has a portion within the range from 380 nm to 590 nm, and the portion has a second area smaller than or equal to 5% of the first color spectrum area.

7. The backlight module as claimed in claim 6, wherein the first color spectrum exhibits a substantially green color, and the second color spectrum exhibits a substantially red color.

8. The backlight module as claimed in claim 6, wherein the backlight module further comprises a package unit with the first and second phosphor layers disposed therein.

9. The backlight module as claimed in claim 8, wherein the package unit forms two recesses with the first and second phosphor layers respectively disposed therein.

10. The backlight module as claimed in claim 6, wherein the backlight module further comprises a plurality of package units with the first and second phosphor layers respectively disposed therein.
